(19) United States
(12) Patent Application Publication
(10) Pub. No.: US 2024/0045737 A1
(43) Pub. Date: Feb. 8, 2024

(54) INFORMATION PROCESSING METHOD AND INFORMATION PROCESSING APPARATUS

(71) Applicant: Fujitsu Limited, Kawasaki-shi (JP)

(72) Inventor: Keisuke TSUGANE, Kawasaki (JP)

(73) Assignee: Fujitsu Limited, Kawasaki-shi (JP)

(21) Appl. No.: 18/329,611

(22) Filed: Jun. 6, 2023

(30) Foreign Application Priority Data
Aug. 5, 2022 (JP) 2022-125237

(51) Int. Cl. G06F 9/52; G06F 9/48

(52) U.S. Cl. CPC G06F 9/52; G06F 9/4881

(57) ABSTRACT

A non-transitory computer-readable recording medium stores a program for causing a computer to execute a process, the process includes acquiring a source code that includes descriptions of a plurality of tasks to be executed in parallel, detecting descriptions of two or more communication tasks each of which controls communication, among the descriptions of the plurality of tasks defined in the acquired source code, and adding a description that forms data dependency between communication tasks chosen in accordance with execution orders of the two or more communication tasks, to each of the detected descriptions of the two or more communication tasks in the acquired source code.

### CROSS-REFERENCE TO RELATED APPLICATION

This application is based upon and claims the benefit of priority of the prior Japanese Patent Application No. 2022-125237, filed on Aug. 5, 2022, the entire contents of which are incorporated herein by reference.

### FIELD

The embodiment discussed herein is related to an information processing method and an information processing apparatus.

### BACKGROUND

In the related art, there is a system in which a process is allocated to each node, one or more threads are generated in the process, and a task is executed on each thread. For example, in the system, in order to exchange data between two processes allocated to different nodes, a communication task for executing communication may be executed on a thread in each process.

As the related art, for example, there is a technique in which context switch is not performed for a unit process in a mode in which one processor sequentially executes by itself a plurality of unit processes branched from the unit process. For example, there is a technique for storing reference information of a floating thread in a high-speed memory. For example, there is a technique in which context switch is not performed at a subroutine level. For example, there is a technique for creating instruction code offset data for allocating a general-purpose register in accordance with the number of registers used for each thread that is an execution unit module of a program.

Japanese Laid-open Patent Publication No. 6-044199, U.S. Patent Application Publication No. 2005/0066302, U.S. Patent Application Publication No. 2005/0102650, and Japanese Laid-open Patent Publication No. 2005-129001 are disclosed as related art.

### SUMMARY

According to an aspect of the embodiment, a non-transitory computer-readable recording medium stores a program for causing a computer to execute a process, the process includes acquiring a source code that includes descriptions of a plurality of tasks to be executed in parallel, detecting descriptions of two or more communication tasks each of which controls communication, among the descriptions of the plurality of tasks defined in the acquired source code, and adding a description that forms data dependency between communication tasks chosen in accordance with execution orders of the two or more communication tasks, to each of the detected descriptions of the two or more communication tasks in the acquired source code.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing method according to an embodiment;

FIG. 2 is a diagram illustrating an example of an information processing system;

FIG. 3 is a block diagram illustrating an example of a hardware configuration of an information processing apparatus;

FIG. 4 is a block diagram illustrating a functional configuration example of the information processing apparatus;

FIG. 5 is a diagram illustrating an example of a context switch function;

FIG. 6 is a diagram (part 1) illustrating an example of converting a source code including a description of a reception task;

FIG. 7 is a diagram (part 2) illustrating the example of converting a source code including a description of a reception task;

FIG. 8 is a diagram (part 1) illustrating an example of converting a source code including a description of a transmission task;

FIG. 9 is a diagram (part 2) illustrating the example of converting a source code including a description of a transmission task;

FIG. 10 is a diagram illustrating an example of a data dependency relationship between tasks;

FIG. 11 is a diagram illustrating an example in which a plurality of tasks are executed in parallel;

FIG. 12 is a diagram illustrating an example of an effect produced by the information processing apparatus; and

FIG. 13 is a flowchart illustrating an example of an overall processing procedure.

### DESCRIPTION OF EMBODIMENT

In the related art, a deadlock of a communication task may occur. For example, when a communication task for transmitting first data is executed in a thread in a first process and a communication task for receiving second data is executed by a thread in a second process, both the communication tasks are not completed and occupy the threads. The second data is data different from the first data. By contrast, it is conceivable to apply a technique called context switch, in which a task to be executed is periodically switched, to a thread in the second process. However, a problem may occur that an increase in overhead is caused and a decrease in performance of a task is caused.

Hereinafter, an embodiment of an information processing method and an information processing apparatus according to the present disclosure will be described in detail with reference to the drawings.

(Example of Information Processing Method According to Embodiment)

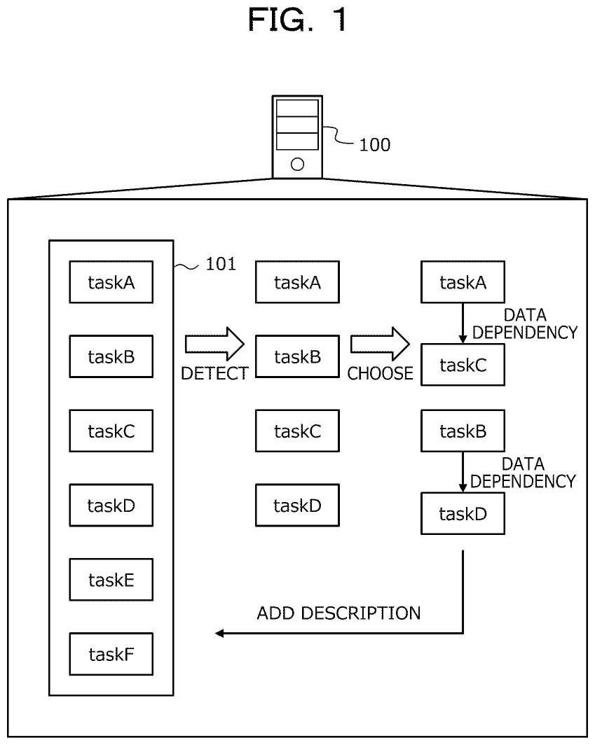

FIG. 1 is a diagram illustrating an example of the information processing method according to the embodiment. An information processing apparatus 100 is a computer for making it easy to avoid a deadlock of a task in a case where a plurality of tasks are executed in parallel. For example, the information processing apparatus 100 is a server, a personal computer (PC), or the like.

For example, there is a system in which a plurality of tasks are executed in parallel by allocating a process to each node, generating one or more threads in the process, and executing different tasks on the respective threads. For example, in the system, in order to exchange data between two processes allocated to different nodes, a communication task for executing communication may be executed on a thread in each process.

However, a deadlock of the communication task may occur. For example, a case is conceivable in which when a thread in a first process among the two processes allocated to different nodes executes a communication task for transmitting first data, a thread in a second process executes a communication task for receiving second data. It is assumed that the second data is data different from the first data.

In this case, when there is one thread in each of the processes, both the communication tasks are not completed and the threads are occupied in the respective processes. For example, when the communication task for transmitting the first data is not completed in the thread in the first process, a communication task for transmitting second data is not started. Thus, the communication task for receiving the second data is not completed in the thread in the second process. Similarly, for example, when the communication task for receiving the second data is not completed in the thread in the second process, a communication task for receiving the first data is not started. Thus, the communication task for transmitting the first data is not completed in the thread in the first process.

As described above, a deadlock of the communication task occurs in the thread in each process of the two processes allocated to the different nodes. Accordingly, it is desirable to avoid the deadlock of the communication task.

In this regard, in the related art, a method is conceivable in which a technique called context switch, in which a task to be executed is periodically switched, is applied to the thread in the second process. In this method, a problem may occur in that an increase in overhead is caused and a decrease in performance of a task executed in a thread in a process is caused.

For example, when a task currently being executed in a thread in a process is saved and restored later, an increase in workload is caused and an increase in overhead is caused. For example, when a plurality of tasks executable in a thread in a process exist, an increase in time taken for the same task to be executed again is caused and an increase in overhead is caused. For this reason, a decrease in performance of the task executed in the thread in the process is caused.

Accordingly, in the present embodiment, an information processing method that may make it easy to avoid a deadlock of a task will be described.

In FIG. 1, (1-1) the information processing apparatus 100 acquires a source code 101 including descriptions of a plurality of tasks to be executed in parallel. For example, the information processing apparatus 100 acquires the source code 101 including the descriptions of the plurality of tasks to be executed in parallel in a first process among two processes allocated to different nodes.

For example, it is assumed that two threads exist in one process, and thus up to two tasks are simultaneously executable in one process. In the example illustrated in FIG. 1, the information processing apparatus 100 acquires the source code 101 including descriptions of tasks taskA to taskF. For example, any one of the nodes may be the information processing apparatus 100.

The plurality of tasks to be executed in parallel in the first process include a communication task for controlling communication. The communication task corresponds to any communication task for controlling communication among a plurality of tasks to be executed in parallel in the second process. When communication tasks corresponding to each other are executed at the same time in the respective processes, each of the communication tasks is normally completed. On the other hand, when the communication tasks corresponding to each other are not executed at the same time in the respective processes, each of the communication tasks is not completed.

(1-2) The information processing apparatus 100 detects descriptions of two or more communication tasks each of which controls communication, among the descriptions of the plurality of tasks defined in the acquired source code 101. In the example illustrated in FIG. 1, the information processing apparatus 100 detects descriptions of the tasks taskA to taskD that are communication tasks among the descriptions of the tasks taskA to taskF described in the source code 101. Accordingly, the information processing apparatus 100 may detect a description of a communication task in which a deadlock may occur.

(1-3) The information processing apparatus 100 adds a description that forms data dependency between communication tasks chosen in accordance with execution orders of the two or more communication tasks, to each of the detected descriptions of the two or more communication tasks in the acquired source code 101. For example, the information processing apparatus 100 adds a description that forms data dependency between communication tasks chosen in accordance with execution orders of the two or more communication tasks determined based on description orders of the two or more communication tasks, to each of the detected descriptions of the two or more communication tasks.

In the example illustrated in FIG. 1, the information processing apparatus 100 determines execution orders of taskA, taskB, taskC, and taskD in the source code 101 in accordance with the description orders of the tasks taskA to taskD. The information processing apparatus 100 adds a description that forms data dependency between communication tasks to the descriptions of the tasks taskA to taskD such that the tasks taskA to taskD are cyclically executed in each thread in the process in accordance with the determined execution order.

For example, the information processing apparatus 100 adds a description that forms data dependency between communication tasks to the descriptions of the tasks taskA to taskD such that a first thread executes taskA and then executes taskC and a second thread executes taskB and then executes taskD. For example, the information processing apparatus 100 adds a description that forms data dependency between taskA and taskC and a description that forms data dependency between taskB and taskD to the descriptions of the tasks taskA to taskD.

Accordingly, the information processing apparatus 100 may control and guarantee the execution orders of the tasks taskA to taskD such that the tasks taskA to taskD are cyclically executed in each thread in a process. For this reason, in the information processing apparatus 100, it is possible to make it easy for the communication tasks corresponding to each other to be executed at the same time in each of two processes allocated to the different nodes, and it is possible to make it easy for the communication tasks to be normally completed.

Accordingly, the information processing apparatus 100 may easily avoid a deadlock between communication tasks. Similarly, the information processing apparatus 100 may acquire the source code 101 including descriptions of a plurality of tasks to be executed in parallel in the second process among the two processes allocated to different nodes, and may add a description that forms data dependency between communication tasks. For this reason, the information processing apparatus 100 may further easily avoid a deadlock between the communication tasks.

Although a case has been described in which the information processing apparatus 100 operates by itself, the embodiment is not limited thereto. For example, there may be a case where the information processing apparatus 100 collaborates with another computer. For example, there may be a case where a plurality of computers implement a function as the information processing apparatus 100. For example, there may be a case where the function as the information processing apparatus 100 is implemented by cloud computing.

(Example of Information Processing System 200)

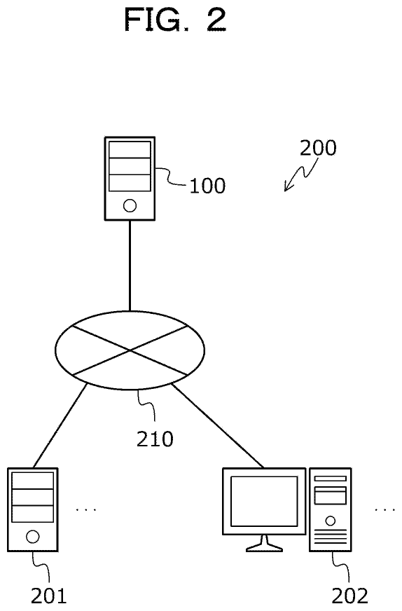

Next, an example of an information processing system 200 in which the information processing apparatus 100 illustrated in FIG. 1 is applied will be described with reference to FIG. 2.

FIG. 2 is a diagram illustrating an example of the information processing system 200. In FIG. 2, the information processing system 200 includes the information processing apparatus 100, one or more node apparatuses 201, and one or more client apparatuses 202.

In the information processing system 200, the information processing apparatus 100 and the node apparatus(es) 201 are coupled to each other via a wired or wireless network 210. For example, the network 210 is a local area network (LAN), a wide area network (WAN), the Internet, or the like. In the information processing system 200, the information processing apparatus 100 and the client apparatus(es) 202 are coupled to each other via the wired or wireless network 210.

The information processing apparatus 100 is a computer for making it easy to avoid a deadlock of a communication task. For each of two processes allocated to different nodes, the information processing apparatus 100 receives, from the client apparatus 202, a source code including descriptions of a plurality of tasks to be executed in parallel in the process.

As in FIG. 1, the information processing apparatus 100 adds a description that forms data dependency between communication tasks to a source code received for each process and including descriptions of a plurality of tasks to be executed in parallel in the process. By transmitting the source code after the addition to the node apparatus 201, the information processing apparatus 100 performs control such that the source code after the addition is executed by different nodes. The information processing apparatus 100 may transmit the source code after the addition to the different node apparatuses 201. For example, the information processing apparatus 100 is a server, a personal computer (PC), or the like.

The node apparatus 201 is a computer that implements a node that executes a source code. The node apparatus 201 may include a plurality of cores or may be a computer that implements a different node for each core. The node apparatus 201 receives the source code after the addition from the information processing apparatus 100. The node apparatus 201 executes a process. The node apparatus 201 generates one or more threads in the process. The node apparatus 201 executes a plurality of tasks defined by the received source code after the addition in parallel in the generated one or more threads. For example, the node apparatus 201 is a server, a PC, or the like.

The client apparatus 202 is a computer used by a system user. The client apparatus 202 generates, for each of two processes allocated to different nodes, a source code including descriptions of a plurality of tasks to be executed in parallel in the process, based on an operational input by the system user. The client apparatus 202 transmits the generated source code to the information processing apparatus 100. The client apparatus 202 is, for example, a PC, a tablet terminal, a smartphone, or the like.

Although a case where the information processing apparatus 100 is an apparatus different from the node apparatus 201 has been described above, the embodiment is not limited thereto. For example, there may be a case where the information processing apparatus 100 has a function as the node apparatus 201, and also operates as the node apparatus 201. Although a case where the information processing apparatus 100 is an apparatus different from the client apparatus 202 has been described, the embodiment is not limited thereto. For example, there may be a case where the information processing apparatus 100 has a function as the client apparatus 202, and also operates as the client apparatus 202.

(Application Example of Information Processing System 200)

For example, it is considered that the information processing system 200 is applied to a case where large-scale arithmetic processing of high-performance computing (HPC) is performed by using a supercomputer. In this case, the supercomputer operates as the node apparatus 201. Examples of the large-scale arithmetic processing include, for example, prediction processing of an earthquake, weather, or the like, image processing, analysis processing of an object or fluid, language processing, or the like.

(Example of Hardware Configuration of Information Processing Apparatus 100)

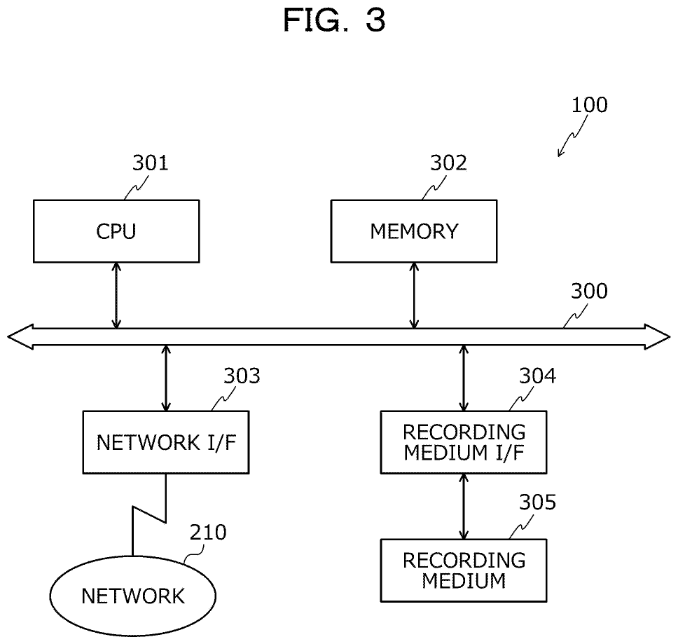

Next, an example of a hardware configuration of the information processing apparatus 100 will be described with reference to FIG. 3.

FIG. 3 is a block diagram illustrating an example of a hardware configuration of the information processing apparatus 100. In FIG. 3, the information processing apparatus 100 includes a central processing unit (CPU) 301, a memory 302, a network interface (I/F) 303, a recording medium I/F 304, and a recording medium 305. The individual components are coupled to each other by a bus 300.

The CPU 301 controls the entire information processing apparatus 100. The memory 302 includes, for example, a read-only memory (ROM), a random-access memory (RAM), a flash ROM, and the like. For example, the flash ROM or the ROM stores various types of programs, and the RAM is used as a work area for the CPU 301. The programs stored in the memory 302 are loaded by the CPU 301, thereby causing the CPU 301 to execute coded processing.

The network I/F 303 is coupled to the network 210 through a communication line, and is coupled to another computer via the network 210. The network I/F 303 controls the interface between the network 210 and the inside, and controls inputs and outputs of data from and to another computer. For example, the network I/F 303 is a modem, a LAN adapter, or the like.

The recording medium I/F 304 controls reading and writing of data from and to the recording medium 305 in accordance with the control of the CPU 301. The recording medium I/F 304 is, for example, a disk drive, a solid-state drive (SSD), a Universal Serial Bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be removably attached to the information processing apparatus 100.

In addition to the components described above, for example, the information processing apparatus 100 may include a keyboard, a mouse, a display, a printer, a scanner, a microphone, a speaker, or the like. The information processing apparatus 100 may include a plurality of recording medium I/Fs 304 and a plurality of recording media 305. The information processing apparatus 100 does not have to include the recording medium I/F 304 or the recording medium 305.

(Example of Hardware Configuration of Node Apparatus 201)

For example, an example of a hardware configuration of the node apparatus 201 is substantially the same as the example of the hardware configuration of the information processing apparatus 100 illustrated in FIG. 3, and thus the description thereof is omitted.

(Example of Hardware Configuration of Client Apparatus 202)

An example of a hardware configuration of the client apparatus 202 is, for example, substantially the same as the example of the hardware configuration of the information processing apparatus 100 illustrated in FIG. 3, and thus the description thereof is omitted.

(Example of Functional Configuration of Information Processing Apparatus 100)

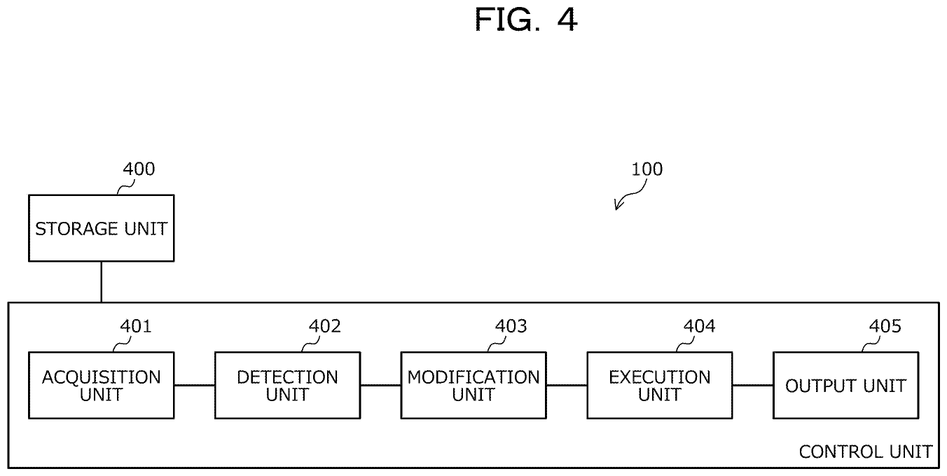

Next, an example of a functional configuration of the information processing apparatus 100 will be described with reference to FIG. 4.

FIG. 4 is a block diagram illustrating an example of a functional configuration of the information processing apparatus 100. The information processing apparatus 100 includes a storage unit 400, an acquisition unit 401, a detection unit 402, a modification unit 403, an execution unit 404, and an output unit 405.

The storage unit 400 is implemented by, for example, a storage area such as the memory 302 or the recording medium 305 illustrated in FIG. 3. Hereinafter, although a case where the storage unit 400 is included in the information processing apparatus 100 will be described, the embodiment is not limited thereto. For example, there may be a case where the storage unit 400 is included in an apparatus different from the information processing apparatus 100 and the information processing apparatus 100 is allowed to refer to a content stored in the storage unit 400.

The acquisition unit 401 to the output unit 405 function as an example of a control unit. For example, the acquisition unit 401 to the output unit 405 implement their functions by causing the CPU 301 to execute a program stored in the storage area such as the memory 302 or the recording medium 305 illustrated in FIG. 3, or by using the network I/F 303. For example, a processing result of each functional unit is stored in the storage area such as the memory 302 or the recording medium 305 illustrated in FIG. 3.

The storage unit 400 stores various types of information to be referred to or updated in processing performed by each functional unit. The storage unit 400 stores a first source code including descriptions of a plurality of first tasks to be executed in parallel. For example, the first source code is acquired by the acquisition unit 401.

The acquisition unit 401 acquires various types of information for use in processing performed by each functional unit. The acquisition unit 401 stores the acquired various types of information in the storage unit 400 or outputs the acquired various types of information to each functional unit. The acquisition unit 401 may output the various types of information stored in the storage unit 400 to each functional unit. For example, the acquisition unit 401 acquires the various types of information based on an operational input by a user of the information processing apparatus 100. For example, the acquisition unit 401 may receive the various types of information from an apparatus different from the information processing apparatus 100.

The acquisition unit 401 acquires the first source code. A plurality of first source codes may exist. For example, the acquisition unit 401 acquires, for each of a plurality of processes allocated to different nodes, a first source code including descriptions of a plurality of first tasks to be executed in parallel in one or more threads in the process.

For example, the acquisition unit 401 acquires the first source code by receiving the first source code from another computer. For example, the another computer is the client apparatus 202. For example, the acquisition unit 401 acquires the first source code by receiving an input of the first source code based on an operational input of the user of the information processing apparatus 100. The user of the information processing apparatus 100 is, for example, a system user.

The acquisition unit 401 may receive a start trigger for starting processing of any functional unit. For example, the start trigger is performing of a predetermined operational input by the user of the information processing apparatus 100. For example, the start trigger may be reception of predetermined information from the another computer. For example, the start trigger may be output of the predetermined information from any functional unit. For example, the acquisition unit 401 may consider the acquisition of the first source code as the start trigger for starting processing of the detection unit 402, the modification unit 403, and the execution unit 404.

Among the descriptions of the plurality of tasks defined in the source code, the detection unit 402 detects a description of a communication task for controlling communication. For example, the detection unit 402 analyzes the acquired first source code and detects descriptions of two or more communication tasks each of which controls communication, among descriptions of a plurality of first tasks defined in the first source code. Accordingly, the detection unit 402 may detect a description of a communication task that may be a cause of occurrence of a deadlock in the first source code, and may obtain a reference for modifying the first source code by the modification unit 403.

The detection unit 402 may detect, in the acquired first source code, a description of a first task for controlling communication and performing an arithmetic operation. By dividing the detected description of the first task into a description of a communication task for controlling the communication and a description of an arithmetic operation task for performing the arithmetic operation, the detection unit 402 may convert the first source code into a second source code.

The second source code includes descriptions of a plurality of second tasks to be executed in parallel. For example, the plurality of second tasks include a communication task of which a description is divided from that of the first task, and an arithmetic operation task. For example, the plurality of second tasks include all the first tasks of which descriptions are not divided among the plurality of first tasks. Accordingly, the detection unit 402 may divide the communication task and the arithmetic operation task that form the first task, may easily execute the arithmetic operation task independently of the communication task, and may increase arithmetic efficiency.

The detection unit 402 detects descriptions of two or more communication tasks each of which controls communication, among descriptions of a plurality of second tasks defined in the converted second source code. Accordingly, the detection unit 402 may detect the description of the communication task that may be a cause of occurrence of a deadlock in the second source code, and may obtain a reference for modifying the second source code by the modification unit 403.

The modification unit 403 modifies a source code. For example, the modification unit 403 adds a description that forms data dependency between communication tasks chosen in accordance with execution orders of the two or more communication tasks, to each of the detected descriptions of the two or more communication tasks in the acquired first source code. The data dependency between two different communication tasks is formed, for example, when each of the two different communication tasks accessing the same data. For example, the access is an input or an output. For example, the access is preferably an output.

For example, the modification unit 403 determines the execution orders of the two or more communication tasks based on description orders of the detected descriptions of the two or more communication tasks in the acquired first source code. For example, the modification unit 403 chooses a communication task pair for which data dependency is formed between communication tasks thereof in accordance with the execution orders of the two or more communication tasks. For example, the modification unit 403 adds a description that forms data dependency between the communication tasks of the chosen communication task pair, to each of the detected descriptions of the two or more communication tasks in the acquired first source code.

For example, the modification unit 403 determines execution orders of the communication tasks by adopting the description orders of the communication tasks as the execution orders of the communication tasks. For example, the modification unit 403 may determine the execution orders of the communication tasks by adopting a reverse order of the description orders of the communication tasks as the execution orders of the communication tasks. For example, the modification unit 403 may determine the execution orders of the communication tasks by converting the description orders of the communication tasks into the execution orders of the communication tasks in accordance with a predetermined rule.

For example, the modification unit 403 sets a constant N. For example, it is preferable that the constant N be equal to or smaller than an upper limit number of communication tasks permitted to perform communication simultaneously. For example, the constant N is the upper limit number of communication tasks permitted to perform communication simultaneously. For example, the modification unit 403 chooses a communication task having an execution order n and a communication task having an execution order n+N as a communication task pair for which data dependency is formed between the communication tasks thereof. Here, n<N, where n is a positive integer. For example, the modification unit 403 adds a description that forms data dependency between the communication tasks of the chosen communication task pair, to each of the detected descriptions of the two or more communication tasks in the acquired first source code.

For example, the modification unit 403 sets a plurality of pieces of element data the number thereof is N. For example, the modification unit 403 adds a description for accessing any piece of element data cyclically selected from the plurality of pieces of element data in accordance with the execution orders of the communication tasks, to each of the detected descriptions of the two or more communication tasks in the first source code. Accordingly, the modification unit 403 may enable the execution orders of the plurality of first tasks to be controlled and guaranteed such that each thread in the process cyclically executes the plurality of first tasks defined by the first source code.

For example, the modification unit 403 adds a description that forms data dependency between communication tasks chosen in accordance with the execution orders of the two or more communication tasks, to each of the detected descriptions of the two or more communication tasks in the acquired second source code. The data dependency between two different communication tasks is formed, for example, when each of the two different communication tasks accessing the same data. For example, the access is an input or an output. For example, the access is preferably an output.

For example, the modification unit 403 determines the execution orders of the communication tasks based on description orders of the detected descriptions of the two or more communication tasks in the acquired second source code. For example, the modification unit 403 chooses a communication task pair for which data dependency is formed between communication tasks thereof in accordance with the execution orders of the two or more communication tasks. For example, the modification unit 403 adds a description that forms data dependency between communication tasks of the chosen communication task pair, to each of the detected descriptions of the two or more communication tasks in the acquired second source code.

For example, the modification unit 403 determines the execution orders of the communication tasks by adopting the description orders of communication tasks as the execution orders of the communication tasks. For example, the modification unit 403 may determine the execution orders of the communication tasks by adopting a reverse order of the description orders of communication tasks as the execution orders of the communication tasks. For example, the modification unit 403 may determine the execution orders of the communication tasks by converting the description orders of communication tasks into the execution orders of the communication tasks in accordance with a predetermined rule.

For example, the modification unit 403 sets a constant N. For example, it is preferable that the constant N be equal to or smaller than an upper limit number of communication tasks permitted to perform communication simultaneously. For example, the constant N is the upper limit number of communication tasks permitted to perform communication simultaneously. For example, the modification unit 403 chooses a communication task having an execution order n and a communication task having an execution order n+N as a communication task pair for which data dependency is formed between the communication tasks thereof. Here, n<N, where n is a positive integer. For example, the modification unit 403 adds a description that forms data dependency between communication tasks of the chosen communication task pair, to each of the detected descriptions of the two or more communication tasks in the acquired second source code.

For example, the modification unit 403 sets a plurality of pieces of element data the number thereof is N. For example, the modification unit 403 adds a description for accessing any piece of element data cyclically selected from the plurality of pieces of element data in accordance with the execution orders of the communication tasks, to each of the detected descriptions of the two or more communication tasks in the second source code. Accordingly, the modification unit 403 may enable the execution orders of the plurality of second tasks to be controlled and guaranteed such that each thread in the process cyclically executes the plurality of second tasks defined by the second source code.

The execution unit 404 compiles a source code, schedules a plurality of tasks defined in the source code by using a runtime, and executes the plurality of scheduled tasks in parallel by using two or more threads. An entity that performs the execution is, for example, the information processing apparatus 100 or the node apparatus 201.

For example, the execution unit 404 compiles the first source code after the addition, schedules the plurality of first tasks by using a runtime, and executes the plurality of scheduled first tasks in parallel by using two or more threads. For example, based on the scheduling result, the execution unit 404 controls the node apparatus 201 such that the node apparatus 201 executes the plurality of scheduled first tasks in parallel by using the two or more threads. Accordingly, the execution unit 404 may control and guarantee the execution orders of the plurality of first tasks.

For example, the execution unit 404 compiles the second source code after the addition, schedules the plurality of second tasks by using a runtime, and executes the plurality of scheduled second tasks in parallel by using two or more threads. For example, based on the scheduling result, the execution unit 404 controls the node apparatus 201 such that the node apparatus 201 executes the plurality of scheduled second tasks in parallel by using the two or more threads. Accordingly, the execution unit 404 may control and guarantee the execution orders of the plurality of second tasks.

The output unit 405 outputs the processing result of at least any of the functional units. For example, an output form is display on a display, output to a printer for printing, transmission to an external apparatus through the network I/F 303, or storage in a storage area such as the memory 302 or the recording medium 305. Accordingly, the output unit 405 is capable of notifying a user of the information processing apparatus 100 of the processing result of at least any of the functional units, thereby improving the convenience of the information processing apparatus 100.

The output unit 405 outputs a modified first source code. For example, the output unit 405 transmits the modified first source code to another computer having a function of executing a source code. For example, the another computer is the node apparatus 201. For example, the output unit 405 may output the modified first source code such that the system user may refer to the modified first source code. Accordingly, the output unit 405 may enable the modified first source code to be executed outside.

The output unit 405 outputs a modified second source code. For example, the output unit 405 transmits the modified second source code to another computer having a function of executing ae source code. For example, the another computer is the node apparatus 201. For example, the output unit 405 may output the modified second source code such that the system user may refer to the modified second source code. Accordingly, the output unit 405 may enable the modified second source code to be executed outside.

The output unit 405 may output the result of parallel execution of the plurality of first tasks performed by the execution unit 404. Accordingly, the output unit 405 may enable the result of parallel execution of the plurality of first tasks defined in the first source code to be used.

The output unit 405 may output the result of parallel execution of the plurality of second tasks performed by the execution unit 404. Accordingly, the output unit 405 may enable the result of parallel execution of the plurality of second tasks defined in the second source code to be used.

Although a case where the information processing apparatus 100 includes the acquisition unit 401, the detection unit 402, the modification unit 403, the execution unit 404, and the output unit 405 has been described, the embodiment is not limited thereto. For example, there may be a case where the information processing apparatus 100 does not include any one of the functional units. For example, there may be a case where the information processing apparatus 100 does not include the execution unit 404. In this case, it is considered that the information processing apparatus 100 may communicate with another computer including the execution unit 404. The information processing apparatus 100 transmits the modified first source code or the modified second source code to the another computer.

(Operation Example of Information Processing System 200)

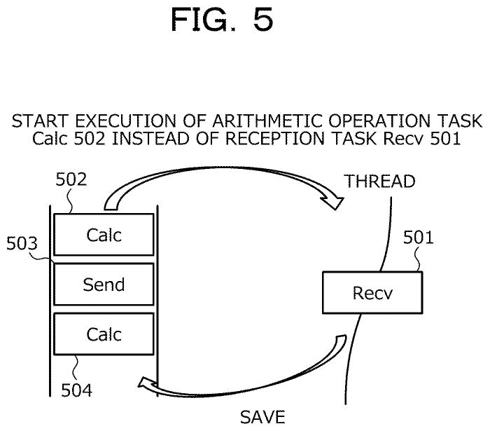

Next, an operation example of the information processing system 200 will be described with reference to FIGS. 5 to 12. First, an example of a context switch function implemented in any of the node apparatuses 201 in the information processing system 200 will be described with reference to FIG. 5.

FIG. 5 is a diagram illustrating an example of the context switch function. As illustrated in FIG. 5, the context switch function is implemented in the node apparatus 201. For example, the node apparatus 201 prepares a first-in first-out queue for managing a task waiting to be executed.

The node apparatus 201 performs the context switch function for a task in a case where the task is not completed even when a certain period of time elapses after the start of execution of the task in a thread in a process. The context switch function is a function of saving a task being executed in a queue and managing the task as a task waiting to be executed, and also taking out a task at a head of the queue and starting execution in the thread in the process.

In the example illustrated in FIG. 5, it is assumed that the node apparatus 201 is executing a reception task Recv 501 for controlling data reception in the thread in the process. It is assumed that the node apparatus 201 is managing an arithmetic operation task Calc 502 for controlling a data arithmetic operation, a transmission task Send 503 for controlling data transmission, and an arithmetic operation task Calc 504 for controlling a data arithmetic operation by sequentially storing the tasks in a queue as tasks waiting to be executed.

In the example illustrated in FIG. 5, in a case where the reception task Recv 501 is not completed even when a certain period of time elapses after the start of execution of the reception task Recv 501 in the thread in the process, the node apparatus 201 saves the reception task Recv 501 in the queue and manages the reception task Recv 501 as a task waiting to be executed. Instead of the reception task Recv 501, the node apparatus 201 takes out the arithmetic operation task Calc 502 at the head of the queue, and starts executing the arithmetic operation task Calc 502 in the thread in the process.

Accordingly, the node apparatus 201 may suppress the task from occupying the thread, thereby making it easy to avoid a deadlock. A problem occurs in that as the number of times that the node apparatus 201 performs the context switch increases, an increase in overhead is caused and a decrease in performance of a task executed in a thread in a process is caused. For this reason, it is desirable to suppress an increase in the number of times that the node apparatus 201 performs the context switch function.

By contrast, an object of the information processing apparatus 100 is to convert a source code including descriptions of a plurality of tasks and then provide the converted source code to the node apparatus 201, thereby making it easy to avoid a deadlock and reducing the number of times the context switch is performed.

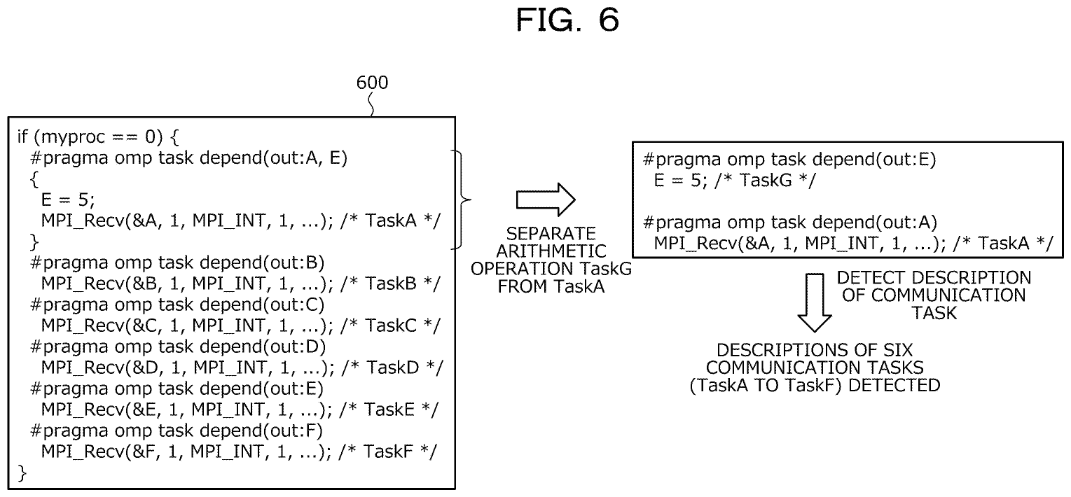

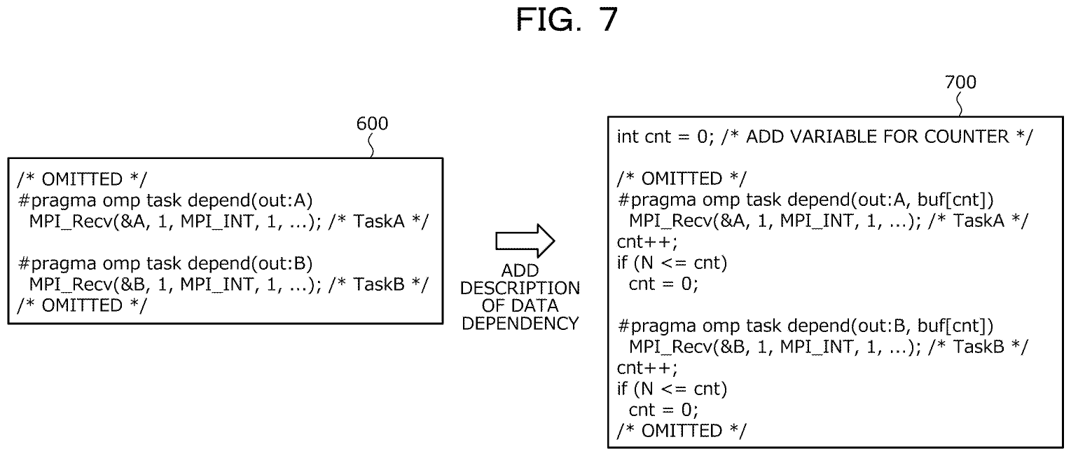

An example in which the information processing apparatus 100 converts a source code 600 including a description of a reception task executed by the node apparatus 201 and a source code 800 including a description of a transmission task executed by the node apparatus 201 will be described with reference to FIGS. 6 to 9. First, an example in which the information processing apparatus 100 converts the source code 600 including a description of a reception task will be described with reference to FIGS. 6 and 7, for example.

FIGS. 6 and 7 are diagrams illustrating an example of converting the source code 600 including a description of a reception task. In FIG. 6, the information processing apparatus 100 acquires the source code 600 including a description of a reception task. The information processing apparatus 100 allocates a buffer buf including N pieces of element data. Here, N is the number of communication tasks simultaneously executable in the process of the node apparatus 201. Hereinafter, there is a case where i-th element data in the buffer buf is referred to as “element data buf[i−1]”. Here, i is an integer of 1 to N.

The information processing apparatus 100 analyzes the source code 600. Based on the result of analyzing the source code 600, the information processing apparatus 100 searches for a description of a complex task for controlling communication and performing an arithmetic operation, in the source code 600. In the example illustrated in FIG. 6, taskA is a complex task for performing an arithmetic operation of E=5 and controlling reception of MPI_Recv( ). Thus, as a result of the search, the information processing apparatus 100 detects the description of taskA that is a complex task in the source code 600.

Accordingly, the information processing apparatus 100 separates a portion for performing the arithmetic operation of E=5 from the detected taskA as taskG while leaving a portion for controlling communication in the detected taskA, in the source code 600. TaskA becomes a communication task for controlling reception of MPI_RecvQ. Accordingly, the information processing apparatus 100 may easily execute the taskG independently of taskA, and may increase the arithmetic efficiency.

Based on the result of analyzing the source code 600, the information processing apparatus 100 searches for a description of a communication task in the source code 600. In the example illustrated in FIG. 6, as a result of the search, the information processing apparatus 100 detects a description of taskA, a description of taskB, a description of taskC, a description of taskD, a description of taskE, and a description of taskF, each of which is a communication task, in the source code 600. Accordingly, the information processing apparatus 100 may detect a description of a communication task that may cause a deadlock, and may obtain a guideline for converting the source code 600. The description now shifts to description of FIG. 7.

In FIG. 7, the information processing apparatus 100 inserts definition “int cnt=0;” of a variable for a counter at a head of the source code 600. The information processing apparatus 100, while cyclically incrementing the variable cnt in a range 0 or more and less than N, adds a description that forms data dependency with another communication task by using an element data buf[cnt] to the description of each communication task in accordance with the description orders of the communication tasks. The description that forms data dependency is, for example, “#pragma omp task depend(out:buf[cnt])”.

In the example illustrated in FIG. 7, the information processing apparatus 100 adds the description “#pragma omp task depend(out:buf[cnt])” that forms data dependency with another communication task to the description of taskA by using the element data buf[cnt]. In order to cyclically increment the variable cnt in the range of 0 or more and less than N, the information processing apparatus 100 adds a description “cnt++” for incrementing the variable cnt and a description for initializing the variable cnt that has become N or more to the description of taskA. The description for initializing is, for example, “if(N<=cnt) cnt=0”.

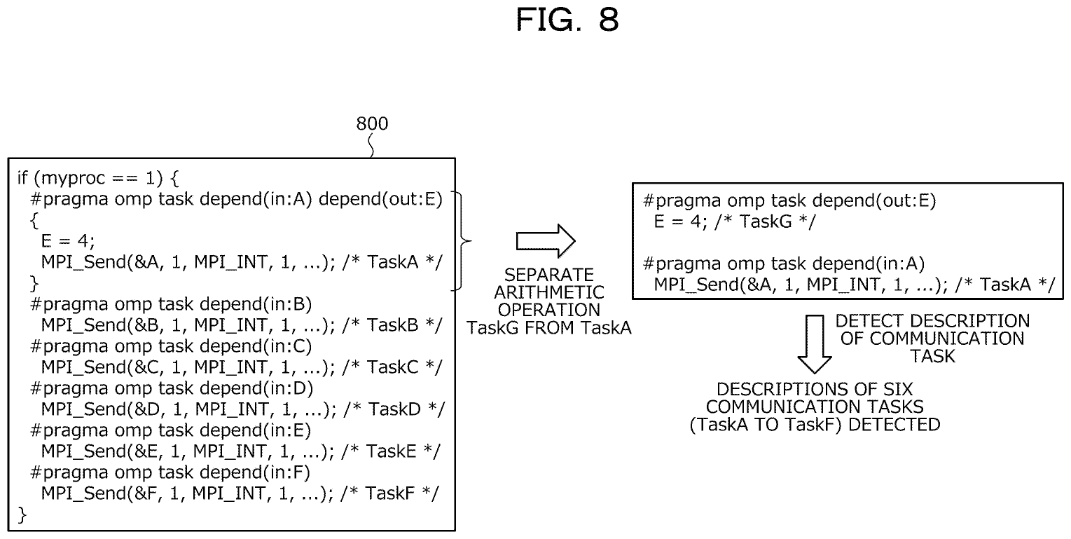

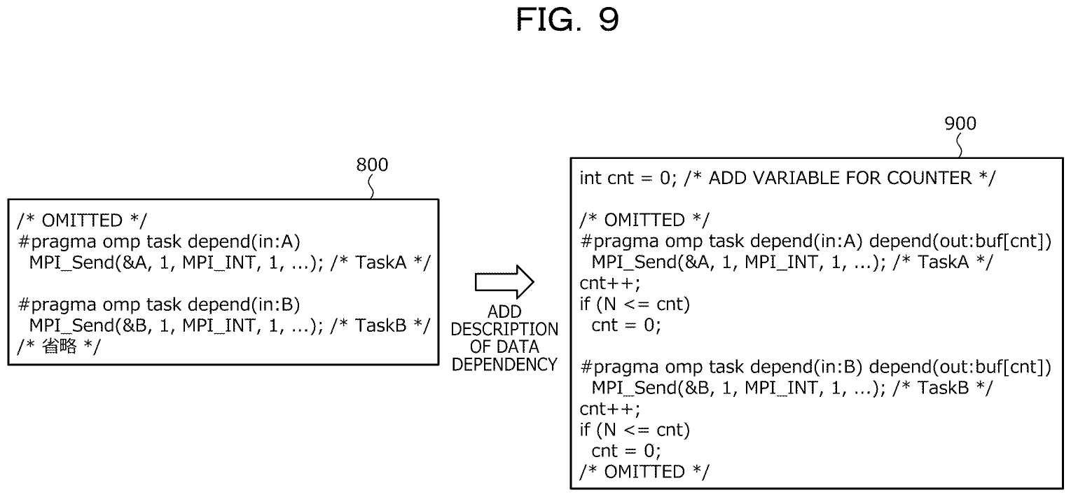

Accordingly, the information processing apparatus 100 may convert the source code 600 into a source code 700. By using the source code 700, the information processing apparatus 100 may control and guarantee the execution orders of taskA, taskB, taskC, taskD, taskE, and taskF. Next, an example in which the information processing apparatus 100 converts the source code 800 including a description of a transmission task will be described with reference to FIGS. 8 and 9.

FIGS. 8 and 9 are diagrams illustrating an example of converting the source code 800 including a description of a transmission task. As illustrated in FIG. 8, the information processing apparatus 100 acquires the source code 800 including a description of a transmission task. The information processing apparatus 100 allocates a buffer buf including N pieces of element data. Here, N is the number of communication tasks simultaneously executable in the process of the node apparatus 201.

The information processing apparatus 100 analyzes the source code 800. Based on the result of analyzing the source code 800, the information processing apparatus 100 searches for a description of a complex task for controlling communication and performing an arithmetic operation in the source code 800. In the example illustrated in FIG. 8, taskA is the complex task for performing an arithmetic operation of E=4 and controlling transmission of MPI_Send( ) Thus, as a result of the search, the information processing apparatus 100 detects the description of taskA that is the complex task in the source code 800.

Accordingly, the information processing apparatus 100 separates a portion for performing the arithmetic operation of E=4 from the detected taskA as a taskG while leaving a portion for controlling communication in the detected taskA, in the source code 800. TaskA becomes a communication task for controlling transmission of MPI_Send( ) Accordingly, the information processing apparatus 100 may easily execute the taskG independently of taskA, and may increase the arithmetic efficiency.

Based on the result of analyzing the source code 800, the information processing apparatus 100 searches for a description of a communication task in the source code 800. In the example illustrated in FIG. 8, as a result of the search, the information processing apparatus 100 detects a description of taskA, a description of taskB, a description of taskC, a description of taskD, a description of taskE, and a description of taskF, each of which is a communication task, in the source code 800. Accordingly, the information processing apparatus 100 may detect a description of a communication task that may cause a deadlock, and may obtain a guideline for converting the source code 800. The description now shifts to description of FIG. 9.

In FIG. 9, the information processing apparatus 100 inserts definition “int cnt=0;” of a variable for a counter at a head of the source code 800. The information processing apparatus 100, while cyclically incrementing the variable cnt in a range 0 or more and less than N, adds a description that forms data dependency with another communication task by using an element data buf[cnt] to the description of each communication task in accordance with the description orders of the communication tasks. The description that forms data dependency is, for example, “#pragma omp task depend(out:buf[cnt])”.

In the example illustrated in FIG. 9, the information processing apparatus 100 adds the description “#pragma omp task depend(out:buf[cnt])” that forms data dependency with another communication task to the description of taskA by using the element data buf[cnt]. In order to cyclically increment the variable cnt in the range of 0 or more and less than N, the information processing apparatus 100 adds a description “cnt++” for incrementing the variable cnt and a description for initializing the variable cnt that has become N or more to the description of taskA. The description for initializing is, for example, “if(N<=cnt) cnt=0”.

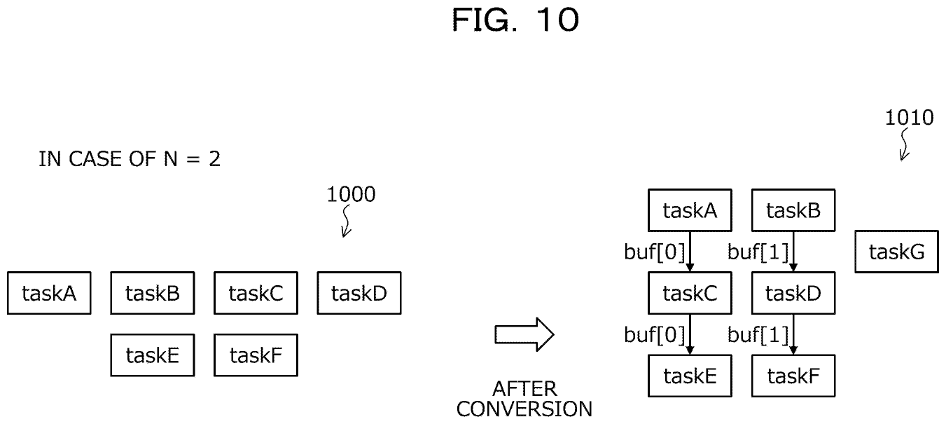

Accordingly, the information processing apparatus 100 may convert the source code 800 into a source code 900. By using the source code 900, the information processing apparatus 100 may control and guarantee the execution orders of taskA, taskB, taskC, taskD, taskE, and taskF. An example of a data dependency relationship between tasks in a case where the information processing apparatus 100 converts the source code 600 into the source code 700 with N=2 will be described with reference to FIG. 10.

FIG. 10 is a diagram illustrating an example of the data dependency relationship between the tasks. As indicated by a reference numeral 1000 in FIG. 10, in the source code 600 before the conversion, no data dependency relationship exists between taskA, taskB, taskC, taskD, taskE, and taskF. For this reason, it is considered that the execution orders of taskA, taskB, taskC, taskD, taskE, and taskF in the process is indefinite.

By contrast, as indicated by a reference numeral 1010, the source code 700 after the conversion may form data dependency relationships between taskA, taskB, taskC, taskD, taskE, and taskF, for example, regarding buf[0], the source code 700 after the conversion may form a data dependency relationship in order of taskA, taskC, and taskE. Thus, it is considered that the execution orders of taskA, taskC, and taskE is fixed.

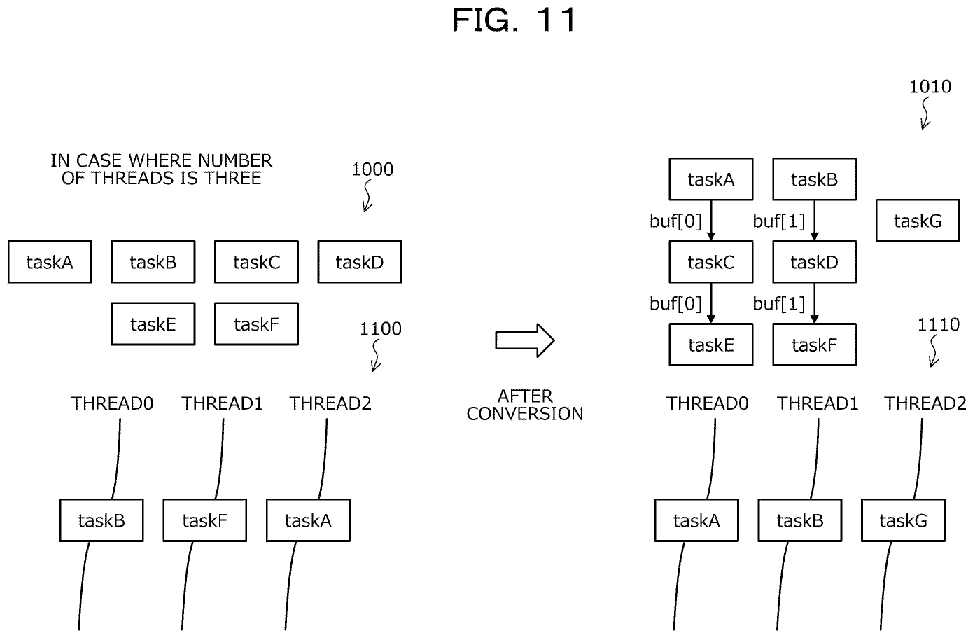

For example, regarding buf[1], the source code 700 after the conversion may form a data dependency relationship in order of taskB, taskD, and taskF, Thus, it is considered that the execution orders of taskB, taskD, and taskF is fixed. Next, an example in which a plurality of tasks defined in the source code 700 are executed in parallel in a thread in a process will be described with reference to FIG. 11.

FIG. 11 is a diagram illustrating an example in which a plurality of tasks are executed in parallel. As illustrated in FIG. 11, the information processing apparatus 100 transmits the source codes 700 and 900 to one or a plurality of node apparatuses 201. Accordingly, the information processing apparatus 100 controls the one or plurality of node apparatuses 201 such that the plurality of tasks defined in the source code 700 and the plurality of tasks defined in the source code 900 are executed by different processes.

In the example of FIG. 11, it is assumed that a first node apparatus 201 having received the source code 700 executes the plurality of tasks defined in the source code 700 in parallel in three threads in the process. As indicated by a reference numeral 1110, the first node apparatus 201 executes taskA in a thread thread0, executes taskB in a thread thread1, and executes the taskG in a thread thread1 in consideration of the data dependency between the communication tasks in accordance with the source code 700.

After taskA is completed in thread0, the first node apparatus 201 executes taskC in thread0. After taskC is completed in thread0, the first node apparatus 201 executes taskE in thread0. After taskB is completed in thread1, the first node apparatus 201 executes taskD in thread1. After taskD is completed in thread1, the first node apparatus 201 executes taskF in thread1. Accordingly, the first node apparatus 201 may execute taskA, taskB, taskC, taskD, taskE, and taskF in the fixed execution order.

Similarly, a second node apparatus 201 having received the source code 900 may execute taskA, taskB, taskC, taskD, taskE, and taskF in the fixed execution order. Accordingly, in the information processing system 200, the first node apparatus 201 and the second node apparatus 201 may easily execute the communication tasks corresponding to each other at the same time. Thus, the information processing system 200 may easily avoid a deadlock.

By contrast, a case is assumed in which the first node apparatus 201 executes taskA, taskB, taskC, taskD, taskE, and taskF in accordance with the source code 600 before the conversion. In this case, the first node apparatus 201 does not necessarily execute taskA, taskB, taskC, taskD, taskE, and taskF in the fixed execution order. For example, as indicated by a reference numeral 1100, it is considered that, according to the source code 600 before the conversion, the first node apparatus 201 executes taskB in thread0, executes taskF in thread1, and executes taskA in thread2.

Similarly, a case is assumed in which the second node apparatus 201 executes taskA, taskB, taskC, taskD, taskE, and taskF in accordance with the source code 800 before the conversion. In this case, the second node apparatus 201 does not necessarily execute taskA, taskB, taskC, taskD, taskE, and taskF in the fixed execution order. It is considered that, according to the source code 800 before the conversion, the second node apparatus 201 executes taskE in thread0, executes taskD in thread1, and executes taskC in thread2.

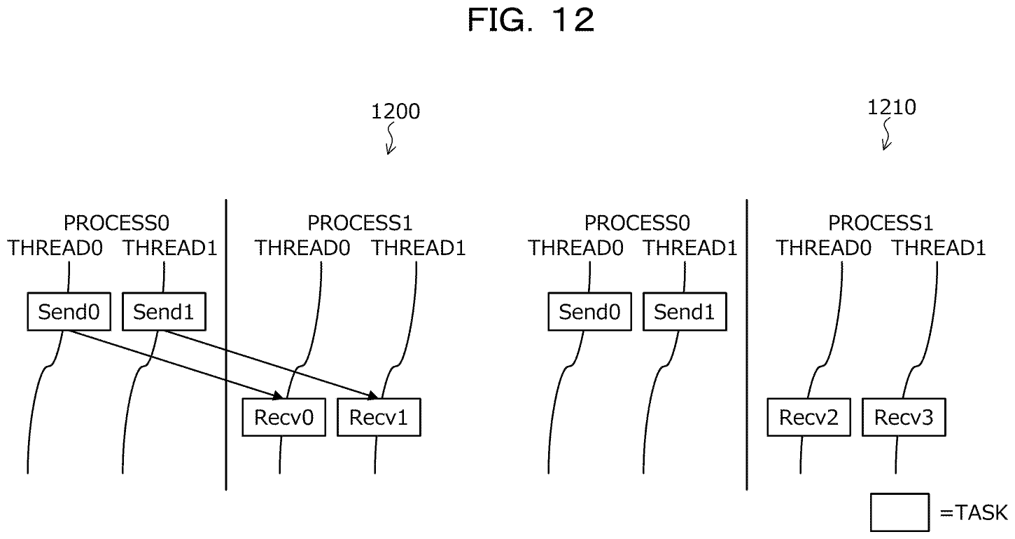

As described above, the first node apparatus 201 and the second node apparatus 201 do not necessarily execute the communication tasks corresponding to each other at the same time. For this reason, according to the related art, there is a case where it is difficult to avoid a deadlock. Accordingly, in the related art, the number of times that the first node apparatus 201 and the second node apparatus 201 perform the context switch may not be reduced, which may cause an increase in overhead. Next, an example of an effect of the information processing apparatus 100 will be described with reference to FIG. 12. For example, avoiding a deadlock will be described with reference to FIG. 12.

FIG. 12 is a diagram illustrating an example of the effect produced by the information processing apparatus 100. As indicated by a reference numeral 1210 in FIG. 12, in the related art, there is a case where, in a process process0 of the second node apparatus 201, thread0 executes a transmission task of Send0 and thread1 executes a transmission task of Send1. The transmission task of Send0 corresponds to a reception task of Recv0. A transmission task of Send1 corresponds to a reception task of Recv1.

Similarly, as indicated by the reference numeral 1210 in FIG. 12, in the related art, there is a case where, in a process process1 of the first node apparatus 201, thread0 executes a reception task of Recv2 and thread1 executes a reception task of Recv3. The reception task of Recv2 corresponds to a transmission task of Send2. The reception task of Recv3 corresponds to a transmission task of Send3.

In process0, when at least one of the transmission task of Send0 or the transmission task of Send1 is not completed, execution of the transmission task of Send2 and the transmission task of Send3 is not started. In process1, when at least one of the reception task of Recv2 or the reception task of Recv3 is not completed, execution of the reception task of Recv0 and the reception task of Recv1 is not started.

Accordingly, in process0, the tasks do not complete while thread0 and thread1 are occupied by the tasks, and in process1, the tasks do not complete while thread0 and thread1 are occupied by the tasks. For this reason, in the related art, it is considered that the probability of occurrence of a deadlock of a task in process0 and process1 is relatively high. It is considered that it is difficult to reduce the number of times the context switch is performed in the related art.

By contrast, as indicated by a reference numeral 1200 in FIG. 12, in process0 of the second node apparatus 201, the information processing apparatus 100 may perform control such that thread0 executes the transmission task of Send0 and thread1 executes the transmission task of Send1.

Similarly, as indicated by the reference numeral 1200 in FIG. 12, in process1 of the first node apparatus 201, the information processing apparatus 100 may perform control such that thread0 executes the reception task of Recv0 and thread1 executes the reception task of Recv1. For this reason, the information processing apparatus 100 may avoid a deadlock. The information processing apparatus 100 may reduce the number of times the context switch is performed.

Although a case where the context switch function is implemented in the node apparatus 201 has been described, the embodiment is not limited thereto. For example, there may be a case where the context switch function is not implemented in the node apparatus 201.

(Overall Processing Procedure)

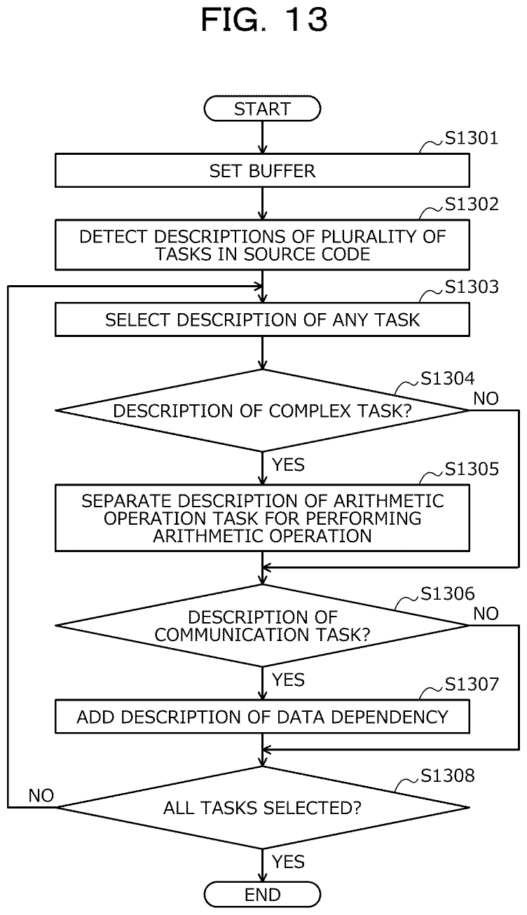

Next, an example of an overall processing procedure executed by the information processing apparatus 100 will be described with reference to FIG. 13. The overall processing is implemented, for example, by the CPU 301, the storage area such as the memory 302 or the recording medium 305, and the network I/F 303 illustrated in FIG. 3.

FIG. 13 is a flowchart illustrating an example of the overall processing procedure. In FIG. 13, the information processing apparatus 100 sets a buffer including as many elements as the number of communication tasks that may perform communication simultaneously (step S1301).

Next, the information processing apparatus 100 analyzes a source code and detects descriptions of a plurality of tasks in the source code (step S1302). The information processing apparatus 100 selects a description of any task that has not been selected yet among the detected descriptions of the plurality of tasks in the source code (step S1303).

Next, the information processing apparatus 100 determines whether the selected description of any task in the source code is a description of a complex task for performing both communication and an arithmetic operation (step S1304). In a case where the description is not a description of a complex task (step S1304: No), the information processing apparatus 100 proceeds to processing of step S1306. On the other hand, in a case where the description is a description of a complex task (step S1304: Yes), the information processing apparatus 100 proceeds to processing of step S1305.

In step S1305, the information processing apparatus 100 separates a description of an arithmetic operation task for performing an arithmetic operation from the selected description of any task in the source code (step S1305). The information processing apparatus 100 proceeds to processing of step S1306.

In step S1306, the information processing apparatus 100 determines whether the selected description of any task in the source code is a description of a communication task for performing communication (step S1306). In a case where the description is not a description of a communication task (step S1306: No), the information processing apparatus 100 proceeds to processing of step S1308. On the other hand, in a case where the description is a description of a communication task (step S1306: Yes), the information processing apparatus 100 proceeds to processing of step S1307.

In step S1307, the information processing apparatus 100 adds a description of data dependency by using the buffer to the selected description of any task in the source code (step S1307). The information processing apparatus 100 proceeds to processing of step S1308.

In step S1308, the information processing apparatus 100 determines whether all the tasks have been selected (step S1308). In a case where there is a task that has not been selected yet (step S1308: No), the information processing apparatus 100 returns to processing of step S1303. On the other hand, in a case where all the tasks have been selected (step S1308: Yes), the information processing apparatus 100 ends the entire processing. Accordingly, the information processing apparatus 100 may easily avoid a deadlock, and may reduce the number of times of performing the context switch.

The information processing apparatus 100 may execute the processing by changing the order of the processing of some steps illustrated in FIG. 13. The information processing apparatus 100 may omit the processing of one or more steps illustrated in FIG. 13. For example, the processing of steps S1304 and S1305 may be omitted.

As described above, according to the information processing apparatus 100, it is possible to acquire a source code including descriptions of a plurality of tasks to be executed in parallel. According to the information processing apparatus 100, it is possible to detect descriptions of two or more communication tasks each of which controls communication among the descriptions of the plurality of tasks defined in the acquired source code. According to the information processing apparatus 100, it is possible to add a description that forms data dependency between communication tasks chosen in accordance with the execution orders of the communication tasks, to each of the detected descriptions of the two or more communication tasks in the acquired source code. Accordingly, the information processing apparatus 100 may easily avoid a deadlock.

According to the information processing apparatus 100, it is possible to compile the source code after the addition, schedule a plurality of tasks by using a runtime, and execute the plurality of scheduled tasks in parallel by using two or more threads. Accordingly, the information processing apparatus 100 may execute the plurality of tasks in parallel while avoiding a deadlock.

According to the information processing apparatus 100, it is possible to determine the execution orders of the communication tasks based on the description orders of the two or more communication tasks. According to the information processing apparatus 100, it is possible to add a description that forms data dependency between communication tasks chosen in accordance with the execution orders of the communication tasks, to each of the detected descriptions of the two or more communication tasks in the acquired source code. Accordingly, the information processing apparatus 100 may easily determine the execution orders of the communication tasks in accordance with an intention of a creator of the source code, and may easily improve the execution efficiency of the plurality of tasks.

According to the information processing apparatus 100, it is possible to set as a plurality of pieces of element data that are as many as the upper limit number of communication tasks permitted to perform communication simultaneously. According to the information processing apparatus 100, it is possible to determine the execution orders of the communication tasks based on the description orders of the two or more communication tasks. According to the information processing apparatus 100, it is possible to add a description for accessing any piece of element data cyclically selected from the plurality of pieces of element data in accordance with the execution orders of the communication tasks, to each of the detected descriptions of the two or more communication tasks. Accordingly, the information processing apparatus 100 may form data dependency by using the element data so as not to hinder a normal operation of the plurality of tasks.

According to the information processing apparatus 100, it is possible to adopt an output of the element data as access. Accordingly, the information processing apparatus 100 may easily add a description for accessing any piece of element data cyclically selected from the plurality of pieces of element data in accordance with the execution orders of the communication tasks, to the description of each communication task. The information processing apparatus 100 may avoid using different forms of data dependency between the communication tasks for input and output.

According to the information processing apparatus 100, it is possible to acquire a source code including descriptions of a plurality of first tasks to be executed in parallel. According to the information processing apparatus 100, it is possible to detect a description of a first task for controlling communication and performing an arithmetic operation in the acquired source code. According to the information processing apparatus 100, it is possible to convert the acquired source code into a new source code by dividing the detected description of the first task into a description of a communication task for controlling communication and a description of an arithmetic operation task for performing an arithmetic operation. According to the information processing apparatus 100, it is possible to detect descriptions of two or more communication tasks each of which controls communication among descriptions of a plurality of second tasks defined in the converted new source code. According to the information processing apparatus 100, it is possible to add a description that forms data dependency between communication tasks chosen in accordance with execution orders of the communication tasks, to each of the detected descriptions of the two or more communication tasks in the converted second source code. Accordingly, the information processing apparatus 100 may divide the description into the communication task and the arithmetic operation task that form the first task, may easily execute the arithmetic operation task independently of the communication task, and may increase the arithmetic efficiency.

The information processing method described in the present embodiment may be implemented by causing a computer, such as a personal computer (PC) or a workstation, to execute a program prepared in advance. The information processing program described in the present embodiment is recorded on a computer-readable recording medium and is read from the recording medium to be executed by the computer. The recording medium is a hard disk, a flexible disk, a compact disc (CD)-ROM, a magneto optical (MO) disc, a Digital Versatile Disc (DVD), or the like. The information processing program described in the present embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
acquiring a source code that includes descriptions of a plurality of tasks to be executed in parallel;
detecting descriptions of two or more communication tasks, each of which controls communication, among the descriptions of the plurality of tasks defined in the acquired source code; and
adding, a description that forms data dependency between communication tasks chosen in accordance with execution orders of the two or more communication tasks, to each of the detected descriptions of the two or more communication tasks in the acquired source code.

2. The non-transitory computer-readable recording medium according to claim 1, the process further comprising:
compiling the source code after the adding;
scheduling the plurality of tasks by using a runtime; and
executing the plurality of scheduled tasks in parallel by using two or more threads.

3. The non-transitory computer-readable recording medium according to claim 1, the process further comprising:
determining the execution orders of the two or more communication tasks based on description orders of the two or more communication tasks.

4. The non-transitory computer-readable recording medium according to claim 3, the process further comprising:
setting a plurality of pieces of element data that are as many as an upper limit number of communication tasks permitted to perform communication simultaneously;
wherein
the added description is a description for forming data dependency with another communication task by accessing any piece of element data cyclically selected from the plurality of pieces of element data in accordance with the execution orders of the communication tasks.

5. The non-transitory computer-readable recording medium according to claim 4, wherein the accessing is outputting of the any piece of element data.

6. The non-transitory computer-readable recording medium according to claim 1, the process further comprising:
acquiring a first source code that includes descriptions of a plurality of first tasks to be executed in parallel;
converting the first source code into a second source code that includes descriptions of a plurality of second tasks to be executed in parallel by dividing a description of a first task for controlling communication and performing an arithmetic operation in the first source code into a description of a communication task for controlling communication and a description of an arithmetic operation task for performing an arithmetic operation;
detecting descriptions of two or more communication tasks each of which controls communication among the descriptions of the plurality of second tasks defined in the second source code; and
adding, the description that forms data dependency between communication tasks chosen in accordance with execution orders of the two or more communication tasks, to each of the detected descriptions of the two or more communication tasks in the second source code.

7. An information processing method, comprising:
acquiring, by a computer, a source code that includes descriptions of a plurality of tasks to be executed in parallel;
detecting descriptions of two or more communication tasks each of which controls communication, among the descriptions of the plurality of tasks defined in the acquired source code; and
adding, a description that forms data dependency between communication tasks chosen in accordance with execution orders of the two or more communication tasks, to each of the detected descriptions of the two or more communication tasks in the acquired source code.

8. An information processing apparatus, comprising:
a memory; and
a processor coupled to the memory and the processor configured to:
acquire a source code that includes descriptions of a plurality of tasks to be executed in parallel;
detect descriptions of two or more communication tasks each of which controls communication, among the descriptions of the plurality of tasks defined in the acquired source code; and
add, a description that forms data dependency between communication tasks chosen in accordance with execution orders of the two or more communication tasks, to each of the detected descriptions of the two or more communication tasks in the acquired source code.
